(19) United States
(12) Patent Application Publication
(10) Pub. No.: US 2024/0116782 A1
(43) Pub. Date: Apr. 11, 2024

(54) SURFACE WATER SULFIDE REDUCTION

(71) Applicant: Clearwater BioLogic LLC, Babbitt, MN (US)

(72) Inventors: Jeffrey John Hanson, Babbitt, MN (US); William Newman, Brooklyn Center, MN (US)

(21) Appl. No.: 18/482,898

(22) Filed: Oct. 8, 2023

Related U.S. Application Data
(60) Provisional application No. 63/414,240, filed on Oct. 7, 2022.

(51) Int. Cl. C02F 1/461

(52) U.S. Cl. CPC C02F 1/46109; C02F 2101/101

(57) ABSTRACT

Devices, systems, and methods for removing hydrogen sulfide from surface water are described herein. One electrode device includes a vessel permeable to water, and a plurality of direct reduced iron (DRI) pellets in contact with one another and contained within the vessel.

### FIELD OF DISCLOSURE

The present disclosure relates generally to a system for the reduction of hydrogen sulfide from surface waters.

### BACKGROUND

Hydrogen sulfide may exist in surface waters. In some cases, hydrogen sulfide may be produced by the conversion of sulfate (SO₄) into hydrogen sulfide as either H₂S or HS⁻ depending on the pH. This process may be carried out by a bioreactor, such as that described in U.S. Pat. Nos. 10,597,318, and/or 11,104,596, the entireties of which are incorporated herein by reference.

Some previous approaches to reducing hydrogen sulfide from surface waters add unwanted chemicals. Some previous approaches are not economically or technically viable.

### BRIEF DESCRIPTION OF THE DRAWINGS

FIG. 1 is diagram of an example system for the reduction of hydrogen sulfide from surface waters in accordance with the principles of this disclosure.

FIG. 2 is an isometric view of an example electrode in accordance with one or more embodiments of the present disclosure.

FIG. 3 is a cross-sectional view of the example electrode illustrated in FIG. 2 in accordance with one or more embodiments of the present disclosure.

FIG. 4 is a cross-sectional view of another example electrode in accordance with one or more embodiments of the present disclosure.

FIG. 5 is a top perspective view of another example electrode in accordance with one or more embodiments of the present disclosure.

FIG. 6 is a top perspective view of the example electrode illustrated in FIG. 5 used in a pair in accordance with one or more embodiments of the present disclosure.

FIG. 7 is an isometric view of a system comprising a plurality of electrodes in operation in accordance with one or more embodiments of the present disclosure.

### DESCRIPTION OF THE PREFERRED EMBODIMENTS

The following description illustrates the manner in which the principles of this disclosure are applied, but is not to be construed as in any sense limiting the scope of the disclosure.

An example system in accordance with the present disclosure includes Direct Reduced Iron (DRI). DRI is a specific type of a class of products that are referred to generally as “sponge iron.” DRI is a premium ore-based metallic (OBM) raw material made by removing chemically-bound oxygen from iron ore (e.g., iron oxide pellets and/or lump ores). DRI can be produced in powder, pellet, lump and/or briquette form. Where the term “DRI pellets” appears herein, such usage is intended to refer to a particular type of DRI known as “cold DRI (CDRI) pellets.” CDRI pellets are generally spherical in shape but not uniform in shape or size. Generally speaking, the pellets are on the order of 1 cm in average diameter, with a range encompassing 4 millimeters to 20 millimeters.

DRI pellets, as known to those of skill in the art, can be formed from iron oxide pellets and/or lump ores (e.g., hematite) without melting. A reactive process can be carried out on these pellets and/or lump ores to remove oxygen therefrom. The resultant DRI pellets contain high iron content and are conductive to electricity. In some cases, DRI pellets are at least 90% iron (e.g., total iron). In some cases, DRI pellets are between 90% and 94% iron. In some cases, DRI pellets are in excess of 95% iron (and up to 97% iron). In contrast, taconite pellets contain approximately 67% iron content and are not electrically conductive.

In addition to iron, DRI pellets typically contain other elements and/or compounds in small proportions including, for instance, carbon (e.g., 1.0 to 4.0%), phosphorus (e.g., 0.005% to 0.09%), Sulfur (e.g., 0.001% to 0.03%), gangue, (e.g., 2.8% to 6%), and trace amounts of manganese, copper, nickel, chromium, molybdenum, tin, lead, and/or zinc. DRI pellets exhibit a bulk density of 1,600 to 1,900 kilograms per cubic meter and an apparent density of 3.4 to 3.6 grams per cubic centimeter.

After reduction in a shaft furnace, DRI pellets are cooled to approximately 50 degrees Celsius where they can be used in a nearby electric arc furnace (EAF). The production of DRI pellets is becoming increasingly common in the iron and steel industries because DRI pellets can be used in EAFs for the production of steel. In contrast to a conventional blast furnace, an EAF heats material using an electric arc. EAFs have well-documented advantages ranging from flexibility and space savings to reduced emissions and lower costs.

The removal of oxygen, discussed above, leaves voids that render DRI pellets porous with an open cell structure compared to iron ore. Embodiments of the present disclosure take advantage of this porosity and increased surface area to remove hydrogen sulfide from water. Hydrogen sulfide may impart a characteristic “rotten egg” taste or smell in water and can have harmful effects to aquatic environments, so its removal is desirable.

Embodiments of the present disclosure include reducing hydrogen sulfide in surface water by applying a voltage between at least two electrodes made from electrically-conductive DRI pellets, which may be referred to herein as “DRI electrodes” or simply “electrodes.” A DRI electrode in accordance with the present disclosure includes a plurality of DRI pellets in electrical contact with one another. The pellets may be kept in contact by their placement in a vessel or container. DRI electrodes in accordance with the present disclosure can be placed in the effluent stream from sulfate-reducing, floating bioreactors, for instance.

Embodiments herein include a cathode and an anode (e.g., a sacrificial anode) at least partially submerged in water containing hydrogen sulfide. Ferrous iron cations and/or ferric iron cations (referred to generally as “iron cations”) can be generated at the anode as Fe⁰→Fe²⁺+2e⁻ and Fe⁰→Fe³⁺+3e⁻, respectively. Once in solution, the iron cations can react with hydrogen sulfide and can precipitate iron sulfide (FeS) via Fe²⁺+HS⁻→FeS+H⁺ in the case of ferrous iron, and 2 Fe³⁺+HS⁻→2 Fe²⁺+S+H⁺ in the case of ferric iron. Because some sulfur may be precipitated as FeS₂ the overall equation for the removal of sulfide by precipitation of iron sulfides can be represented as Fe²⁺+2 Fe³⁺+4 HS⁻→Fe₃S₄+4 H⁺ (Nielsen, Asbjorn Haaning, Thorkild Hvitved-Jacobsen, and Jes Vollertsen. “Effects of pH and Iron Concentrations on Sulfide Precipitation in Wastewater Collection Systems.” Water Environment Research 80, no. 4 (2008): 380-84. http://www.jstor.org/stable/23804334). The electrolysis of water can also produce H⁺ at the anode by 2H₂O→O₂+4 H⁺+4e⁻. H⁺ formed by both electrolysis and sulfide reactions can be converted to hydrogen gas (Hz) at the cathode by 2H⁺+2e⁻→H₂ In some embodiments, elemental sulfur may be precipitated at the anode by 2 HS⁻→H₂+2 S+2e⁻ (Nielsen, Asbjorn Haaning, Thorkild Hvitved-Jacobsen, and Jes Vollertsen. “Effects of pH and Iron Concentrations on Sulfide Precipitation in Wastewater Collection Systems.” Water Environment Research 80, no. 4 (2008): 380-84. http://www.jstor.org/stable/23804334). In some embodiments, DRI pellets can be used as alternating anodes and cathodes to regenerate reduced iron at the cathode and prevent loss of conduction from oxidized iron surfaces.

The resultant FeS is a usable byproduct for other remediation processes and can have a value. The hydrogen produced could potentially have value in the reductive process to make DRI or as a fuel for internal combustion engines.

Embodiments of the present disclosure are differentiated from electrolysis. Electrolysis can produce hydrogen from water and uses electrodes to provide the energy to break apart water, H₂O, into its components of hydrogen, H₂, and oxygen, O₂. Pure water has a low conductivity, so salts are often added to the water to produce the necessary electrical current for electrolysis. Embodiments herein do not need to add anything to the water prior to treatment because the dissolved hydrogen sulfide in the form of HS⁻ and other dissolved minerals in the wastewater provide sufficient conductivity to produce the electrical current to flow between electrodes. Systems in accordance with the present disclosure are to react with H₂S and not specifically with H₂O.

Embodiments of the present disclosure are differentiated from electrocoagulation. The electrocoagulation process is a well-known process to use iron electrodes to produce iron cations at a sacrificial anode and to electrolyze H₂O into oxygen and H⁺ at the anode as well as remove H⁺ at the cathode by the production of hydrogen gas. This then forms iron hydroxide in solution, Fe(OH)₂. This iron hydroxide molecule is a heavy molecule that helps in the flocculation and sedimentation of particles. This process, however, is not intended to treat hydrogen sulfide. It uses electrolysis to form hydroxides for the purpose of coagulation. Electrocoagulation can be carried out using iron or aluminum sacrificial anodes. These anodes have a surface chemistry that is acidic and produces dissolved metals (e.g., oxidized iron such as ferrate). At the cathode there may be an alkaline pH, producing hydroxides that can help form flocculating agents like iron hydroxides. With sulfide, there is a unique chemistry where the sulfide may tend to form an insoluble iron sulfide precipitate when any form of iron is in the water (e.g., as seen in the patented PRI-SC method). As previously discussed, it is possible that embodiments herein will precipitate some elemental sulfur from the partial oxidation of iron sulfide to elemental sulfur, however embodiments primarily use electrodes to inject iron cations into water without adding other chemicals, such as chloride, for instance.

Unlike electrodes of the present disclosure (e.g., electrodes made of pellets) most prior art electrodes are plates or rods of solid metal. Electrodes herein exhibit high surface area. DRI pellets exhibit surface area exceeding 0.33 square meters per gram (3,300 square centimeters/gram) (e.g., approximately 0.38 square meters per gram, for example. An electrode made from a one gram plate of iron 0.1 cm thick with two surfaces exposed would have an iron volume of about one gram/7.8 grams/cubic centimeter about 0.128 cubic centimeters. If the thickness of the plate is 0.1 cm, then the area of the two sides (not including the thin edges) is about 1.28 square centimeters on each side (2.56 square centimeters for both). Pellets such as those described herein have about 1,300 times more reactive surface area if the open porosity makes all the internal surface area reactive.

Embodiments herein utilize DRI pellets which are comparatively low cost (e.g., about $200/ton). In contrast, a 0.25 inch×8 inch×24 inch grey iron plate may sell for $216. This is only about 0.0068 tons of iron in this plate, which is about 147 times higher cost for the iron material. DRI Pellets require no fabrication cost and are easy to replace in tubes.

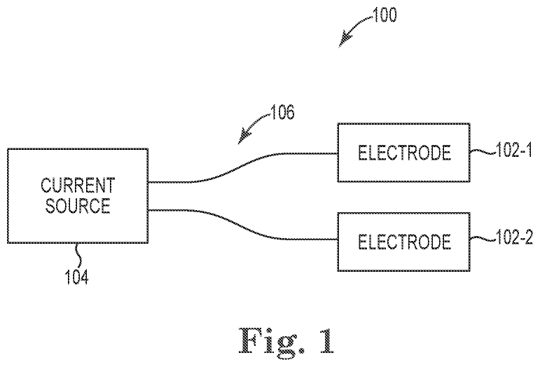

FIG. 1 illustrates a diagram of a system 100 for sulfide reduction in accordance with one or more embodiments of the present disclosure. As shown in the example illustrated in FIG. 1, the system 100 includes a current source 104 connected to a first electrode 102-1 and a second electrode 102-2 (cumulatively referred to as “electrodes 102”). It is noted that while two electrodes are shown, embodiments herein are not limited to a particular quantity of electrodes. The current source 104 can be any suitable current source capable of supplying a voltage between the electrodes 102 such that a current flows between the electrodes 102. In some embodiments, the current is a direct current (DC).

In some embodiments, the electrode 102-1 is a cathode and the electrode 102-2 is an anode. In other embodiments, the electrode 102-1 is an anode and the electrode 102-2 is a cathode. In other embodiments, the current source 104 is configured to alternate such that the electrodes 102 are each cathode and anode at different times. Stated differently, the current source can cause the electrodes 102 to periodically switch between cathode and anode.

It is noted that the voltage supplied can depend on the type, size, and/or spacing of the electrodes described herein, in addition to the conductivity of the water. In some embodiments, for instance, the voltage is between 12 volts and 30 volts DC. In embodiments using cylindrical electrodes (discussed further below), voltages in this range can be applied across multiple cylindrical electrodes that are 2 inches by 20 inches of wetted area, which produces 0.5 to 12 Watts of power per electrode. It is noted that the power can depend on the conductivity of the water and the electrode interface.

Some example voltages and/or amperages include 12 volts DC with a current of 9 amps across 18 cylindrical (e.g., tubular) electrodes, 18 volts DC with a current of 17 amps across 18 cylindrical electrodes, 30 volts DC with a current of 118 amps across 18 cylindrical electrodes, and 24 volts DC with a current of 115 amps across 9 cylindrical electrodes. In general, the higher the amperage, the more iron cations are formed. Both voltage and amperage can be controlled to provide desired cation production while limiting electrolysis. Lower voltages produce primarily iron sulfide precipitate while higher voltages also produce iron hydroxide, which aids in electrocoagulation and settling, and electrolyze more water into oxygen and hydrogen (which increases hydrogen production).

The current source 104 can be connected to the electrodes 102 by wires 106, though embodiments of the present disclosure do not limit the connection between the current source 104 and the electrodes to a particular type of electrical connection. Where the term “wire” is used herein, it is to be understood that such usage is for example purposes and refers generally to any suitable electrical connection.

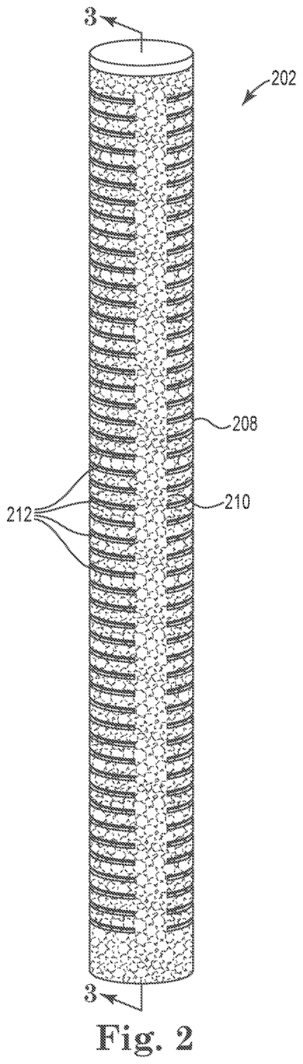

As discussed in FIGS. 2, 3, and 4, the electrodes 102 can include (e.g., be) DRI pellets contained in a vessel. In some embodiments, the DRI pellets are contained in a cylindrical vessel. In some embodiments, the DRI pellets are contained in a rectangular vessel. A plurality of DRI pellets can function as a single electrode by being electrically conductive and by being in physical contact with one another. In some embodiments, the wires 106 are affixed directly to one or more DRI pellets of the electrodes 102 (e.g., via soldering, clamping, etc.). In some embodiments, the wires 106 are connected to a conductive material that is embedded in, against, surrounding, or otherwise in contact with, the DRI pellets. In some embodiments, for example, the wires are connected to a conductive rod that extends through a plurality of DRI pellets.

FIG. 2 is an isometric view of an example electrode 202 in accordance with one or more embodiments of the present disclosure. The electrode 202 includes a plurality of DRI pellets 210 contained within a vessel 208. The vessel 208 shown in FIG. 2 is a cylindrical vessel but it is to be understood that vessels in accordance with the present disclosure can be any suitable vessel that can be submerged (e.g., partially submerged) in water and can contain DRI pellets. The vessel 208 can be permeable to water. In some embodiments, the vessel 208 can include a plurality of surfaces defining a plurality of openings 212 that allow the passage of water into, and out of, the vessel 208. In some embodiments, the vessel 212 is rigid (e.g., a pipe). In other embodiments, the vessel is flexible (e.g., a mesh bag).

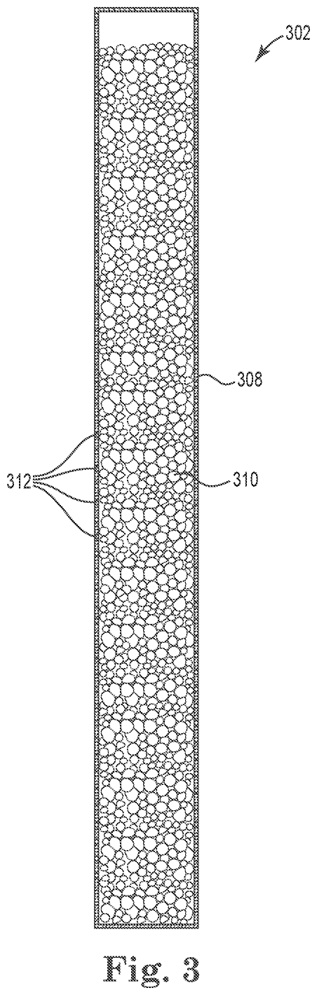

FIG. 3 is a cross-sectional view of the example electrode illustrated in FIG. 2 in accordance with one or more embodiments of the present disclosure. As shown in FIG. 3, and in a manner analogous to that discussed in connection with FIG. 2, the electrode 302 includes a plurality of DRI pellets 310 contained within a vessel 308 that includes a plurality of openings 312.

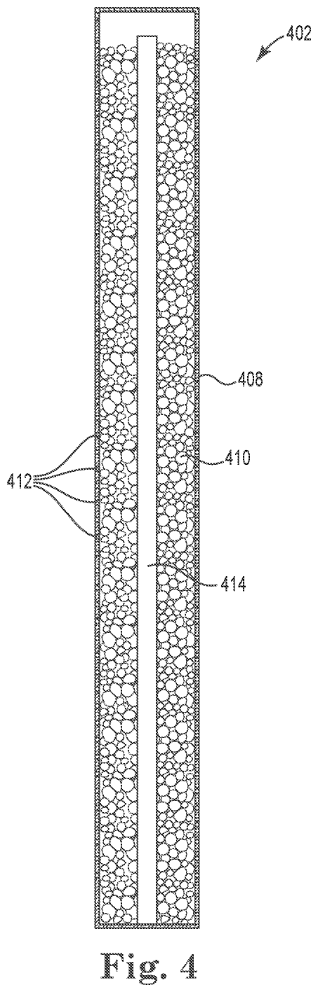

FIG. 4 is a cross-sectional view of another example electrode 402 in accordance with one or more embodiments of the present disclosure. The electrode 402 is analogous to the electrode 202 and the electrode 302, previously described in connection with FIGS. 2 and 3, respectively, but includes a conductive component 414 that extends through the plurality of DRI pellets 410. The conductive component is a graphite rod in some embodiments. The conductive component 414 can increase the conductivity of the electrode 402 along its entire length compared to the electrode 202 and/or the electrode 302. Embodiments of the present disclosure are not limited to a particular shape of the conductive component 414.

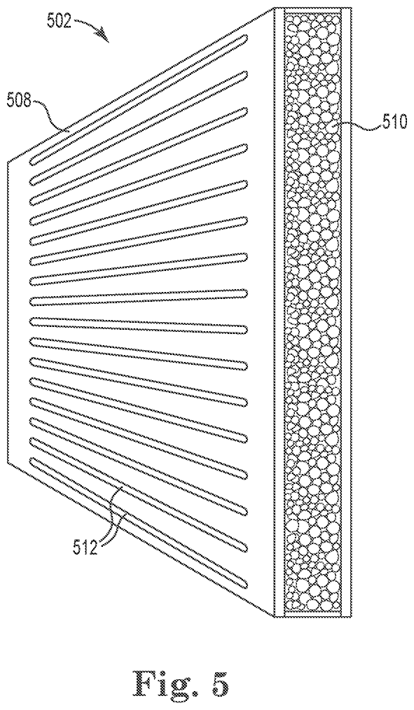

FIG. 5 is a top perspective view of another example electrode 502 in accordance with one or more embodiments of the present disclosure. As shown in the example illustrated in in FIG. 5, the vessel 508 (and therefore the electrode 502) is substantially rectangular or box-shaped and is filled with DRI pellets 510. Slots 512 can be defined on one or more of the surfaces of the vessel 508 to allow the passage of water. For example, the slots 512 can be located on a surface that faces a corresponding electrode. In some embodiments, a conductive component (not shown in FIG. 5) can be included inside the vessel 508. For example, a graphite fabric sheet (e.g., cloth) can be placed against one of the major surfaces of the vessel 508 (e.g., before the DRI pellets are added). Such a sheet can be placed against the surface that opposes a corresponding electrode (e.g., the surface opposing the slots 512). In some embodiments, one or more of the surfaces of the vessel 508 itself may be made of a conductive material.

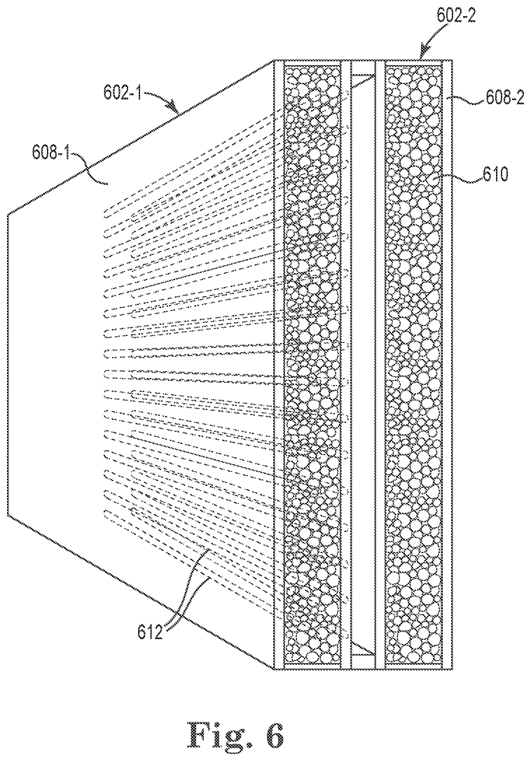

FIG. 6 is a top perspective view of the example electrode 502 illustrated in FIG. 5 used in a pair in accordance with one or more embodiments of the present disclosure. As shown in the example illustrated in in FIG. 6, the vessel 608-1 and the vessel 608-2 (cumulatively referred to as “vessels 608”) are substantially rectangular or box-shaped and are filled with DRI pellets 610. Slots 612 can be defined on the interior (e.g., facing) surfaces of the vessels 608 to allow the passage of water. In some embodiments, a conductive component (not shown in FIG. 6) can be included inside the vessel 608-1 and/or the vessel 608-2. For example, a graphite fabric sheet (e.g., cloth) can be placed against one of the major surfaces of the vessel 608-1 and/or the vessel 608-2 (e.g., before the DRI pellets are added). Such a sheet can be placed against the outer surface, opposing the other electrode (e.g., the surfaces opposing the slots 612). In some embodiments, one or more of the surfaces of the vessel 608-1 and/or the vessel 608-2 themselves may be made of a conductive material. The electrode 602-1 serves as the anode and the electrode 602-2 serves as the cathode, in some embodiments. The electrode 602-1 serves as the cathode and the electrode 602-2 serves as the anode, in some embodiments. In some embodiments, as previously discussed, the electrodes 602 can alternate being the cathode and the anode according to a predetermined and/or user-defined schedule.

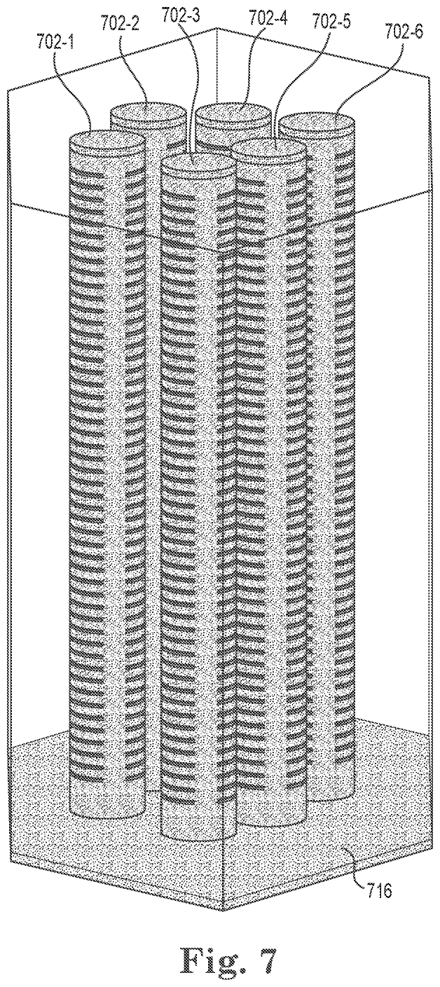

FIG. 7 is an isometric view of a system comprising a plurality of electrodes in operation in accordance with one or more embodiments of the present disclosure. As shown in FIG. 7, the plurality of electrodes includes a first electrode 702-1, a second electrode 702-2, a third electrode 702-3, a fourth electrode 702-4, a fifth electrode 702-5, and a sixth electrode 702-6 (cumulatively referred to as “electrodes 702”). While six electrodes are shown in the example illustrated in FIG. 7, it is noted that embodiments of the present disclosure are not limited to a particular quantity of electrodes.

The electrodes 702 are at least partially submerged in water containing hydrogen sulfide. In some embodiments, half (e.g., three) of the electrodes 702 serve as anodes and the other half of the electrodes 702 serve as cathodes at a given point in time. Iron cations are generated at the anodes as Fe⁰→Fe²⁺+2e⁻ or Fe⁰→Fe³⁺+3e⁻. Once in solution, the iron cations can react with hydrogen sulfide and can precipitate iron sulfide (FeS) 716 via Fe²⁺+HS⁻→FeS+H⁺ in the case of ferrous iron, and 2 Fe³⁺+HS⁻→2 Fe²⁺+S+H⁺ in the case of ferric iron. Because some sulfur may be precipitated as FeS₂ the overall equation they provide can be represented as Fe²⁺+2 Fe³⁺+4 HS⁻→Fe₃S₄+4 H⁺. The hydrogen formed (H⁺) can be converted to hydrogen gas (Hz) at the cathodes by 2H⁺+2e⁻→H₂, for instance.

The present disclosure is not limited to particular devices or methods, which may vary. The terminology used herein is for the purpose of describing particular embodiments, and is not intended to be limiting. As used herein, the singular forms “a”, “an”, and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.”

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An electrode device for removing hydrogen sulfide from surface water comprising:
a vessel permeable to water; and
a plurality of direct reduced iron (DRI) pellets in contact with one another and contained within the vessel.

2. The device of claim 1, wherein the plurality of DRI pellets are comprised of at least 95 percent iron by weight.

3. The device of claim 1, wherein the plurality of DRI pellets are comprised of at least 97 percent iron by weight.

4. The device of claim 1, wherein each of the plurality of DRI pellets has a surface area exceeding 0.32 square meters per gram.

5. The device of claim 1, wherein the DRI pellets are formed from a reduction of iron oxide pellets.

6. The device of claim 1, further comprising a conductive component extending through the plurality of DRI pellets.

7. The device of claim 6, wherein the conductive component is a graphite rod.

8. The device of claim 1, further comprising a conductive component adjacent to the plurality of DRI pellets and contained within the vessel.

9. The device of claim 8, wherein the conductive component is a graphite sheet.

10. A system for removing hydrogen sulfide from surface water, comprising:
a first electrode including a first vessel containing a first plurality of direct reduced iron (DRI) pellets;
a second electrode including a second vessel containing a second plurality of DRI pellets; and
a current source connected to the first electrode and the second electrode.

11. The system of claim 10, wherein the first vessel and the second vessel are each cylindrical.

12. The system of claim 10, wherein the first vessel and the second vessel are rectangular prisms.

13. The system of claim 10, wherein each of the first vessel and the second vessel include a plurality of openings.

14. The system of claim 10, wherein neither the first vessel nor the second vessel is made of a conductive material.

15. The system of claim 10, further comprising:
a third electrode including a third vessel containing a third plurality of DRI pellets and connected to the current source; and
a fourth electrode including a fourth vessel containing a fourth plurality of DRI pellets and connected to the current source.

16. A method for removing hydrogen sulfide from water, comprising:
passing a current through water containing hydrogen sulfide between a first electrode and a second electrode, wherein the first and second electrodes each include a respective vessel containing direct reduced iron (DRI) pellets; and
precipitating iron sulfide from the water.

17. The method of claim 16, wherein the method includes:
using the first electrode as a cathode; and
using the second electrode as an anode.

18. The method of claim 16, wherein the method includes periodically using the first electrode as the anode and second electrode as the cathode.

19. The method of claim 16, wherein the method includes receiving the water containing hydrogen sulfide from an outlet of a sulfate-reducing floating bioreactor.

20. The method of claim 16, wherein the method includes producing an effluent hydrogen sulfide concentration less than 0.4 mg/L.
